(19) United States
(12) Patent Application Publication
(10) Pub. No.: US 2012/0093961 A1
(43) Pub. Date: Apr. 19, 2012

(54) MOULD HAVING MOVABLE MOLD INSERT

(75) Inventors: XIAN-YUN WANG, Tu Cheng (TW); Xiao-ping Wu, Tu Cheng (TW); Shih-hsiung Ho, Tu Cheng (TW)

(73) Assignee: Cheng Uei Precision Industry Co., Ltd., Tu Cheng City (TW)

(21) Appl. No.: 12/907,978

(22) Filed: Oct. 19, 2010

(51) Int. Cl. B29C 33/12

(52) U.S. Cl. 425/414

(57) ABSTRACT

Provided is a mould having movable mold insert, including a male mold, a female mold, a movable mold insert and a mold insert positioning mechanism. The female mold is located just above the male mold and disposes a plurality of core pins. The movable mold insert is movable connected to the male mold. The movable mold insert disposes a plurality of inserting holes corresponding to the core pins. The mold insert positioning mechanism includes a positioning hole and a positioning post matched with the positioning hole. The positioning hole is formed on the movable mold insert, and the positioning post is fixed to the female mold. A protruding length from the bottom surface of the female mold, of the positioning post, is larger than that of the core pins. The mould of the present invention can protect the movable mold insert and greatly improve the product quality.

### BACKGROUND OF THE INVENTION

1. Field of the Invention

The present invention relates to a mould, and more particularly to a mould having movable mold insert.

2. Description of the Prior Art

Mould industry is a base industry of manufacturing industry. With the continuous updating of products and the improvement of technical level, the product quality and the production efficiency need satisfy the high requirement. Therefore, the demand to the mould design is increasingly high. To a traditional mould, a mold insert is fixedly mounted to a mould base of the mould so that extending the production cycle and reducing the production efficiency. With the continuous development of the mould, a replaceable movable mold insert is created. After completion of molding, the replaceable movable mold insert is pulled out of the mould base and an another movable mold insert is directly placed into the mould base for next production cycle, thereby greatly saving the time of dismounting and replacing the mould, and improving the production efficiency.

However, as shown in FIGS. 1 and 2, the prior mould having movable mold insert comprises a male mold 10′, a female mold 20′ and a movable mold insert 30′. The movable mold insert 30′ is replaceable received in the male mold 10′. The female mold 20′ disposes a plurality of core pins 22′, and the movable mold insert 30′ disposes a plurality of inserting holes 32′ corresponding to the core pins 22′. As shown in FIG. 1, when closing the mould, each one of the core pins 22′ is inserted into the corresponding inserting hole 32′. But because the movable mold insert 30′ is movable connected to the male mold 10′ and the replacement action is manually operated, the movable mold insert 30′ is usually misplaced during the placement thereof. It is resulted that the core pins 22′ of the female mold 20′ will collide with the surface of the movable mold insert 30′ and easily destroy the movable mold insert 30′ when the male mold 10′ and the female mold 20′ are closed, as shown in FIG. 2. Therefore, the prior mould cannot assure the product quality.

### BRIEF SUMMARY OF THE INVENTION

An object of the present invention is to provide a mould having movable mold insert for exactly aligning a movable mold insert with a male mold and a female mold, preventing one surface of the movable mold insert from being destroyed, protecting the movable mold insert and greatly improving the product quality.

To achieve the above object, in accordance with the present invention, a mould having movable mold insert is provided, comprising a male mold, a female mold, a movable mold insert and a mold insert positioning mechanism. The male mold and the female mold are engaged with each other. The female mold is located just above the male mold and disposes a plurality of core pins protruding out of a bottom surface thereof. The male mold disposes a recess. The movable mold insert is received in the recess and is movable connected to the male mold. The movable mold insert disposes a plurality of inserting holes being one-to-one corresponding to the core pins. The mold insert positioning mechanism includes a positioning hole and a positioning post matched with the positioning hole. The positioning hole is formed on the movable mold insert, and the positioning post is fixed to the female mold and protrudes out of the bottom surface of the female mold. A protruding length from the bottom surface of the female mold, of the positioning post, is larger than that of the core pins.

Based on the above description, the mould having movable mold insert in the present invention employs the positioning post of the female mold and the positioning hole of the movable mold insert to realize the alignment of the core pins and the inserting holes. Because the protruding length from the bottom surface of the female mold, of the positioning post, is larger than that of the core pins, the positioning post can first slide into the positioning hole when closing the mould. Therefore, the core pins can be aligned with the inserting holes of the movable mold insert for being exactly inserted into the corresponding inserting holes. The mould of the present invention employs the mold insert positioning mechanism to realize the exact alignment between the movable mold insert, the male mold and the female mold, so that preventing the surface of the movable mold insert from being destroyed when closing the mould, protecting the movable mold insert and greatly improving the product quality.

### BRIEF DESCRIPTION OF THE DRAWINGS

FIG. 1 is a structure schematic view of a prior mould for showing that a prior movable mold insert is engaged with a male mold and a female mold;

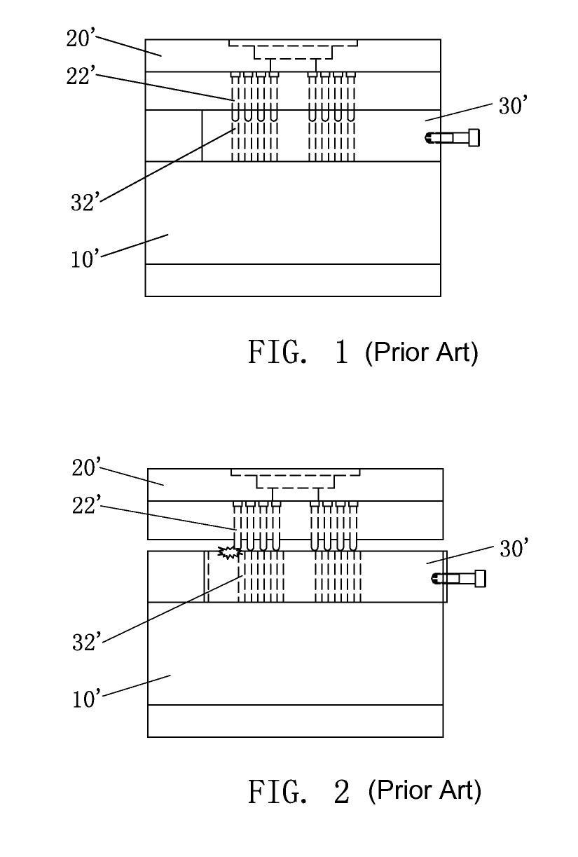

FIG. 2 is a structure schematic view of a prior mould for showing that the prior movable mold insert is collided by core pins; and

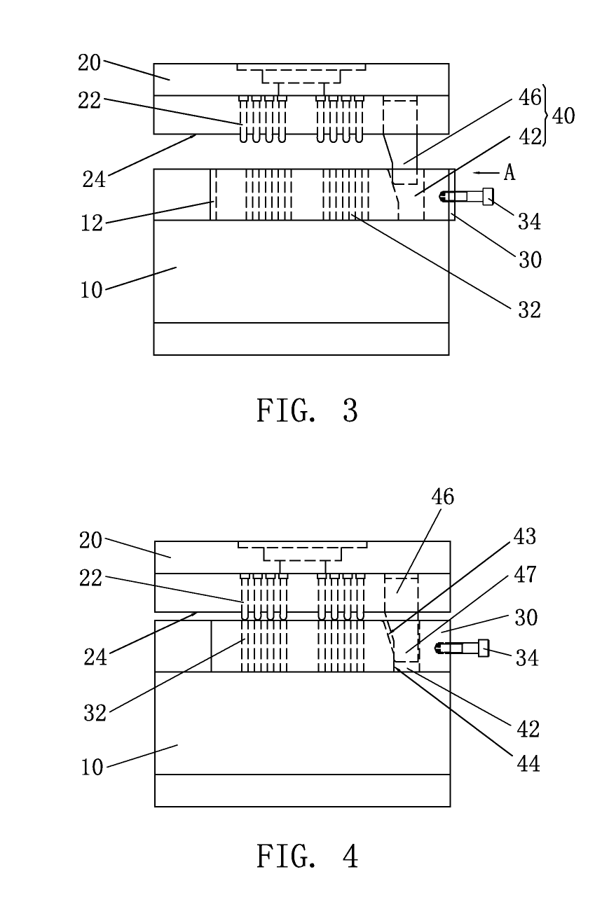

FIGS. 3 to 5 are structure schematic views of the different mounting states of a mould having movable mold insert according to one embodiment of the present invention.

### DETAILED DESCRIPTION OF THE PREFERRED EMBODIMENTS

The following embodiment with reference to the accompanying drawings now has been given for detail describing the technology, the feature, the object and the effect of the present invention.

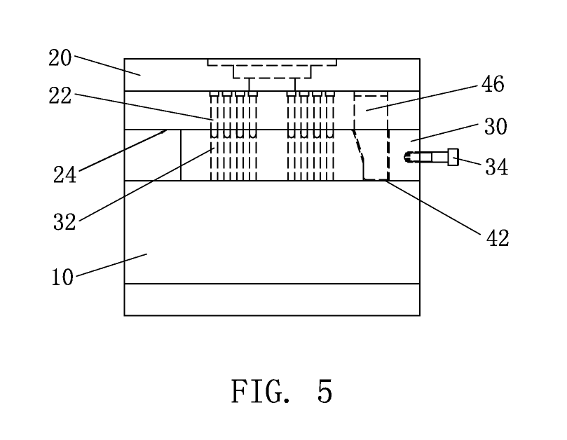

Please refer to FIGS. 3 and 4, a mould having movable mold insert in the present invention comprises a male mold 10, a female mold 20, a movable mold insert 30 and a mold insert positioning mechanism 40, which are engaged with each other. The male mold 10 is horizontally placed and the female mold 20 is located just above the male mold 10. The female mold 20 disposes a plurality of core pins 22 protruding out of a bottom surface 24 thereof, and the male mold 10 disposes a recess 12. The movable mold insert 30 is received in the recess 12 and is movable connected to the male mold 10. A bolt 34 is fixedly mounted on the movable mold insert 30 and is served as a handle for conveniently pulling and replacing the movable mold insert 30. The movable mold insert 30 disposes a plurality of inserting holes 32 provided for inserting the core pins 22. The inserting holes 32 are in a one-to-one correspondence with the core pins 22. The number of the inserting holes 32 and the core pins 22 are determined by the actual demand.

The mold insert positioning mechanism 40 includes a positioning hole 42 and a positioning post 46 engaged with the positioning hole 42. The positioning hole 42 is formed on the movable mold insert 30. Specifically, the sections of the positioning hole 42 and the positioning post 46 are rectangle. The positioning hole 42 has a tilted guiding portion 43 on a front inner wall thereof relative to the sliding direction of the movable mold insert 30, and a holding portion 44 extending vertically downward from the guiding portion 43. The positioning post 46 is fixed to the female mold 20 and is protruding out of the bottom surface 24 of the female mold 20. The protruding length from the bottom surface 24 of the female mold 20, of the positioning post 46, is larger than that of the core pins 22. The profile of the positioning post 46 is matched with the contour of the positioning hole 42. When the mould being closed, the positioning post 46 is completely received in the positioning hole 42.

Referring to FIGS. 3 to 5, the position process of the mold insert positioning mechanism 40 in the mould of the present invention is described as follows. Firstly, the movable mold insert 30 horizontally slides into the recess 12 of the male mold 10 along a direction shown by an arrow A in FIG. 3. But because the movable mold insert 30 is movable connected to the male mold 10 and the operation is manually performed, the movable mold insert 30 does not arrive at the determined position. When closing the mould, the female mold 20 vertically moves downward, as shown in FIG. 3, a front end 47 of the positioning post 46 along the downward movement direction is first contacted with the guiding portion 43 of the positioning hole 42, and exerts a pushing force toward a horizontal left direction on the tilted guiding portion 43 during the downward movement. So the guiding portion 43 of the positioning hole 42 can be driven to move toward the left till the front end 47 of positioning post 46 starts to fall into the holding portion 44 of the positioning hole 42, as shown in FIG. 4.

With the help of the mold insert positioning mechanism 40, the core pins 22 can be aligned with the inserting holes 32 to be smoothly inserted into the corresponding inserting holes 32. As shown in FIG. 5, finally the positioning post 46 completely fits into the positioning hole 42. Understandably, the specific structures of the male mold 10, the female mold 20 and other modules in the embodiment of the present invention are known by one skilled in the art and need not be described again.

As described above, the mould of the present invention employs the positioning post 46 disposed on the female mold 20 and the positioning hole 42 disposed on the movable mold insert 30 to realize the alignment of the core pins 22 and the inserting holes 32. Because the protruding length from the bottom surface 24 of the female mold 20, of the positioning post 46, is larger than that of the core pins 22, the positioning post 46 can first slide into the positioning hole 42 when closing the mould. Therefore, the core pins 22 can be aligned with the inserting holes 32 of the movable mold insert 30 for being exactly inserted into the corresponding inserting holes 32. The mould of the present invention employs the mold insert positioning mechanism 40 to realize the exact alignment between the movable mold insert 30, the male mold 10 and the female mold 20, so that preventing the surface of the movable mold insert 30 from being destroyed when closing the mould, protecting the movable mold insert 30 and greatly improving the product quality.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A mould having movable mold insert comprising:
a male mold, disposing a recess;
a female mold, being engaged with the male mold and being located just above the male mold, wherein the female mold disposes a plurality of core pins protruding out of a bottom surface thereof;
a movable mold insert, being received in the recess and being movable connected to the male mold, wherein the movable mold insert disposes a plurality of inserting holes being one-to-one corresponding to the core pins; and
a mold insert positioning mechanism, including a positioning hole and a positioning post matched with the positioning hole, wherein the positioning hole is formed on the movable mold insert, the positioning post is fixed to the female mold and protrudes out of the bottom surface of the female mold, and a protruding length from the bottom surface of the female mold, of the positioning post, is larger than that of the core pins.

2. The mould having movable mold insert as claimed in claim 1, wherein the sections of the positioning hole and the positioning post are rectangle.

3. The mould having movable mold insert as claimed in claim 2, wherein the positioning hole has a tilted guiding portion on a front inner wall thereof relative to the sliding direction of the movable mold insert, and a holding portion extending vertically downward from the guiding portion, and the profile of the positioning post is matched with the contour of the positioning hole.
